(19) United States
(12) Patent Application Publication
(10) Pub. No.: US 2024/0362556 A1
(43) Pub. Date: Oct. 31, 2024

(54) SYSTEM AND METHOD FOR ENRICHING CLOUD USAGE DATA

(71) Applicant: ORACLE INTERNATIONAL CORPORATION, Redwood Shores, CA (US)

(72) Inventors: Christopher Tolton, Seattle, WA (US); Manan Syal, Seattle, WA (US); Sakthivel Balasubramanian, Bothell, WA (US); Jonathan Li, Seattle, WA (US); Jianan Jiang, Seattle, WA (US)

(21) Appl. No.: 18/639,807

(22) Filed: Apr. 18, 2024

Related U.S. Application Data
(60) Provisional application No. 63/462,878, filed on Apr. 28, 2023.

(51) Int. Cl. G06Q 10/0631

(52) U.S. Cl. CPC G06Q 10/06313

(57) ABSTRACT

In accordance with an embodiment, systems and methods are provided for enriching cloud usage data in order to reduce end-to-end latency for use of such data. Entity maps are provided that can be utilized in order to join enriching metadata to raw usage data. Such enrichment of raw usage data can be utilized to reduce end-to-end latency, negating or removing several steps that negatively contribute to the end-to-end latency including the collecting of the usage data from the service teams at the metering hour intervals, the collecting of the metadata to be associated with the collected usage data, the enriching of the usage data with the proper metadata, the pricing of the usage, and then the step of ultimately preparing an invoice based on the priced usage.

### CLAIM OF PRIORITY AND CROSS-REFERENCE TO RELATED APPLICATIONS

This application claims the benefit of priority to U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,878, filed Apr. 28, 2023; and is related to U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,868, filed Apr. 28, 2023; U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,875, filed Apr. 28, 2023; U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,880, filed Apr. 28, 2023; U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,882, filed Apr. 28, 2023; and U.S. Provisional Patent Application titled “SYSTEM AND METHOD FOR PROVIDING DEDICATED CLOUD ENVIRONMENTS FOR USE WITH A CLOUD COMPUTING INFRASTRUCTURE”, Application No. 63/462,885, filed Apr. 28, 2023; each of which above applications and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to systems and methods for providing cloud environments, for use by tenants of a cloud infrastructure environment in accessing software products, services, or other offerings associated with the environment, including systems and methods for enriching cloud usage data.

### BACKGROUND

A cloud computing environment can be used to provide access to a range of complementary cloud-based components, such as software applications or services, that enable organizations or enterprise customers to operate their applications and services in a highly-available hosted environment.

The benefits to an organization in moving their application and service needs to a cloud environment include a reduction in the cost and complexity of designing, building, operating, and maintaining their own on-premise data center, software application framework, or other information technology infrastructure; allowing them to instead focus on managing their day-to-day business.

Subscription plan management (SPM) cloud service systems typically require service teams to generate regularly occurring reports on usage of cloud resources by customers. The cloud resources may be grouped in compartments of the cloud service system that are accessible by designated customers associated with those compartments. The compartments define boundaries that may contain computer resources, database resources, block volume resources, and any other tools or services that might be made available by the cloud host to their customers associated with their respective compartments. The regularly occurring usage reports from the service teams, however, include only rudimentary information relating to the particular resources that were used including information on the resource type, the compartment in which the resource resides, and the time of use of the resource.

### SUMMARY

Embodiments described herein are generally related to systems and methods for providing cloud environments, for use by tenants of a cloud infrastructure environment in accessing software products, services, or other offerings associated with the environment, including enriching cloud usage data.

Systems and methods are provided for enriching cloud usage data in order to reduce end to end latency for use of such data. Entity maps are provided that can be utilized in order to join enriching metadata to raw usage data. Such enrichment of raw usage data can be utilized to reduce end-to-end latency, negating or removing several steps that negatively contribute to the end-to-end latency including the collecting of the usage data from the service teams at the metering hour intervals, the collecting of the metadata to be associated with the collected usage data, the enriching of the usage data with the proper metadata, the pricing of the usage, and then the step of ultimately preparing an invoice based on the priced usage.

In accordance with an embodiment, a method for enriching cloud usage data can be provided. The method can be performed in a computer system including a processor device and a non-transitory memory device operatively coupled with the processor device. The method can store, in the non-transitory memory, a dataset comprising time-series data representative of enrichment metadata. The method can receive, from an associated source, a stream of usage data representative of use at a reported first time of a first cloud resource of a cloud service system, the usage data comprising a resource identification parameter that identifies the first cloud resource from among a plurality of cloud resources available in the cloud service system, the usage data comprising a first usage time parameter that indicates the reported first time. The method can join a first set of the enrichment metadata with the stream of usage data to generate a first stream of enriched usage data, wherein the first set of the enrichment metadata is selected from the dataset based on the resource identification parameter and the first usage time parameter.

### BRIEF DESCRIPTION OF THE DRAWINGS:

FIG. 1 illustrates a system for providing a cloud infrastructure environment, in accordance with an embodiment.

FIG. 2 further illustrates how a cloud infrastructure environment can be used to provide cloud-based applications or services or services, in accordance with an embodiment.

FIG. 3 illustrates an example cloud infrastructure architecture, in accordance with an embodiment.

FIG. 4 illustrates another example of a cloud infrastructure architecture, in accordance with an embodiment.

FIG. 5 illustrates another example of a cloud infrastructure architecture, in accordance with an embodiment.

FIG. 6 illustrates another example of a cloud infrastructure architecture, in accordance with an embodiment.

FIG. 7 illustrates a system that provides dedicated or private label cloud environments, for use by tenants or customers of a cloud infrastructure environment, in accordance with an embodiment.

FIG. 8 further illustrates the use of cloud realms, for use by tenants or customers of a cloud infrastructure environment, in accordance with an embodiment.

FIG. 9 further illustrates the use of cloud realms, for use by tenants or customers of a cloud infrastructure environment, in accordance with an embodiment.

FIG. 10 illustrates a system for providing access to software products or services in a cloud computing or other computing environment, in accordance with an embodiment.

FIG. 11 illustrates a system for supporting enriching cloud usage data, in accordance with an embodiment.

FIG. 12 is a diagram showing a method for consuming or updating an entity map, in accordance with an embodiment.

FIG. 13 is a diagram of cost computation, in accordance with an embodiment.

FIG. 14 is a diagram of cost computation, in accordance with an embodiment.

FIG. 15 is a flowchart a method for enriching cloud usage data, in accordance with an embodiment.

### DETAILED DESCRIPTION:

A cloud computing or cloud infrastructure environment can be used to provide access to a range of complementary cloud-based components, such as software applications or services, which enable organizations or enterprise customers to operate their applications and services in a highly-available hosted environment.

The benefits to an organization in moving their application and service needs to a cloud infrastructure environment include a reduction in the cost and complexity of designing, building, operating, and maintaining their own on-premise data center, software application framework, or other information technology infrastructure; allowing them to instead focus on managing their day-to-day business.

### Cloud Infrastructure Environments

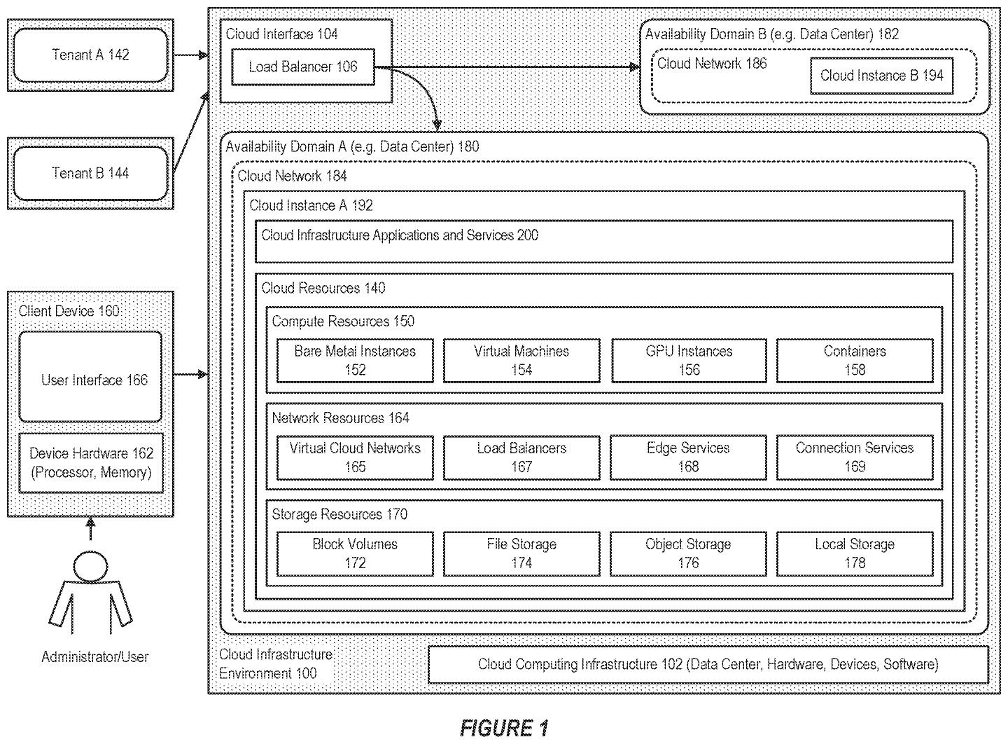

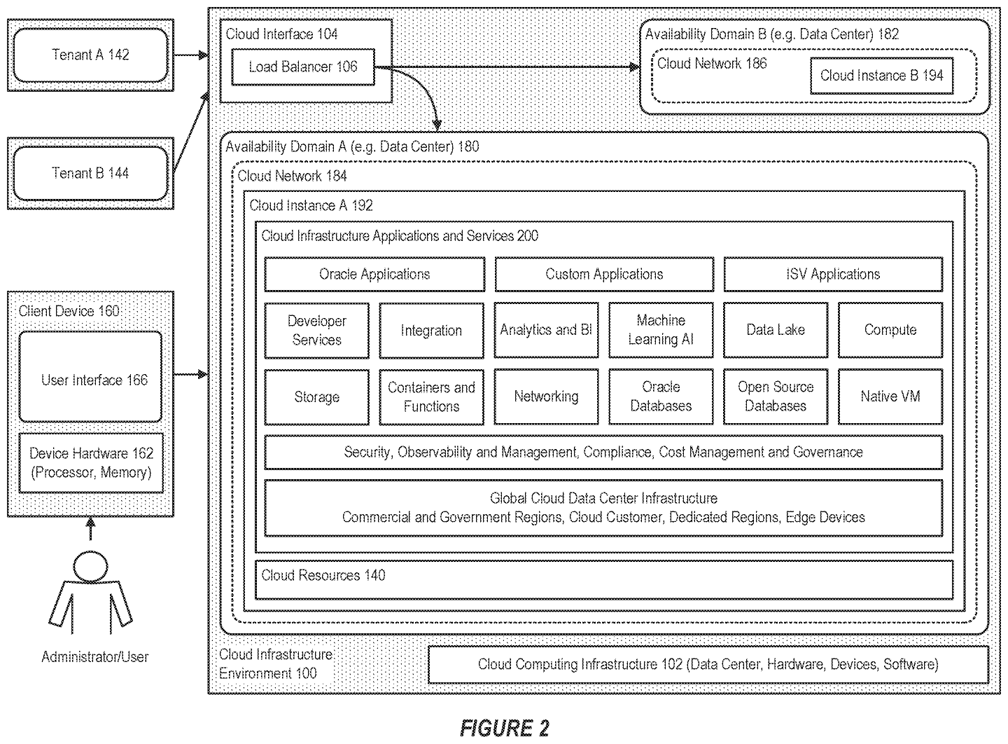

FIGS. 1 and 2 illustrate a system for providing a cloud infrastructure environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers 106.

In accordance with an embodiment, the cloud infrastructure environment supports the use of availability domains, such as, for example, availability domains A 180, B 182, which enables customers to create and access cloud networks 184, 186, and run cloud instances A 192, B 194.

In accordance with an embodiment, a tenancy can be created for each cloud tenant/customer, for example tenant A 142, B 144, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 160 having a device hardware 162 (e.g., processor, memory), and graphical user interface 166, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 140 via, for example, a compute resources layer 150, a network resources layer 164, and/or a storage resources layer 170. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 152, virtual machines 154, graphical processing unit (GPU) compute cloud instances 156, and/or containers 158. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 165, load balancers 167, edge services 168, and/or connection services 169.

In accordance with an embodiment, the storage resources layer can comprise a number of resources, such as, for example, data/block volumes 172, file storage 174, object storage 176, and/or local storage 178.

As illustrated in FIG. 2, in accordance with an embodiment, the cloud infrastructure environment can include a range of complementary cloud-based components, for example as cloud infrastructure applications and services 200, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

For example, in accordance with an embodiment, such an environment can include racks physically and managed by a cloud infrastructure provider; customer's racks; access for cloud operations personnel for setup and hardware support; customer's data center power and cooling; customer's floor space; an area for customer's data center personnel; and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's public cloud regions, such as, for example, ERP, Financials, HCM, and SCM. A customer can seamlessly lift and shift legacy workloads using the cloud infrastructure provider's services, for example bare metal compute, VMs, and GPUs; database services, for example Autonomous Database; or container-based services, for example Container Engine for Kubernetes.

In accordance with an embodiment, a cloud infrastructure environment can operate according to infrastructure-as-a-service (IaaS) model that enables the environment to provide virtualized computing resources over a public network (e.g., the Internet).

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components (example services include billing software, monitoring software, logging software, load balancing software, or clustering software). Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not be, a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries, or daemons). This is often managed by the cloud infrastructure provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In accordance with an embodiment, IaaS provisioning may refer to acquiring computers or virtual hosts for use, and even installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

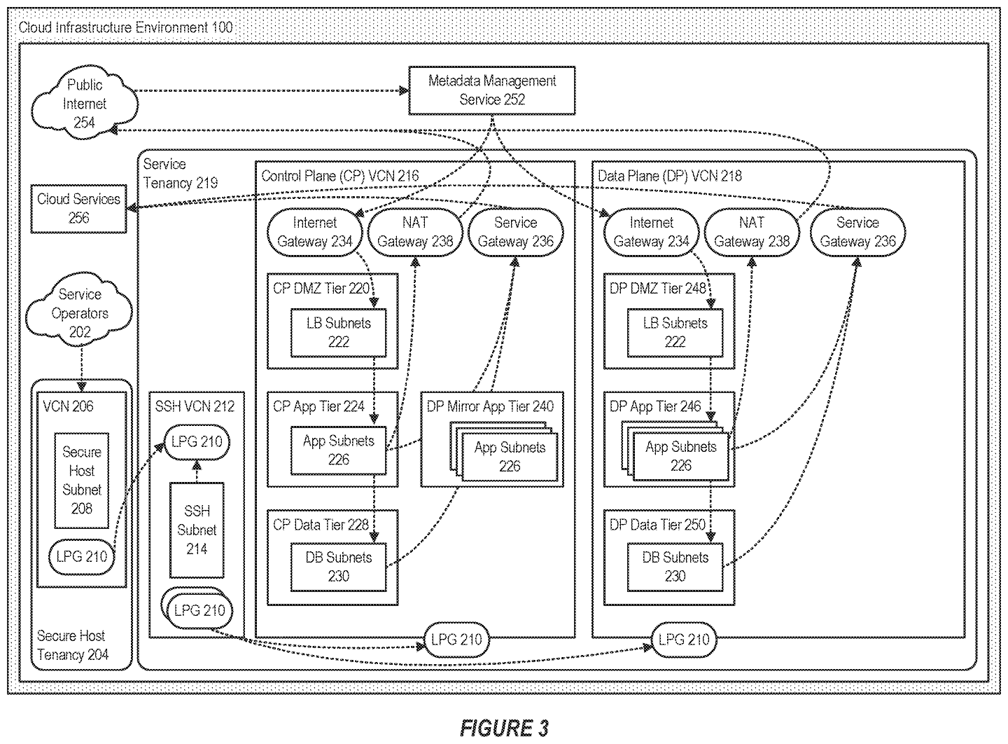

FIG. 3 illustrates an example cloud infrastructure architecture, in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices, which may be portable handheld devices (e.g., a telephone, a computing tablet, a personal digital assistant (PDA)) or wearable devices (e.g., a head mounted display), running software such as Microsoft Windows, and/or a variety of mobile operating systems such as iOS, Android, and the like, and being Internet, e-mail, short message service (SMS), or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Chrome. Alternatively, or in addition, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnet(s) 222, a control plane app tier 224 that can include app subnet(s) 226, and a control plane data tier 228 that can include database (DB) subnet(s) 230 (e.g., frontend DB subnet(s) and/or backend DB subnet(s)). The LB subnet(s) contained in the control plane DMZ tier can be communicatively coupled to the app subnet(s) contained in the control plane app tier, and an Internet gateway 234 that can be contained in the control plane VCN, and the app subnet(s) can be communicatively coupled to the DB subnet(s) contained in the control plane data tier and a service gateway 236 and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier 246, a data plane DMZ tier 248, and a data plane data tier 250. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way: the service gateway can make API calls to cloud services, and cloud services can send requested data to the service gateway. Generally, cloud services may not initiate API calls to the service gateway.

In accordance with an embodiment, the secure host tenancy can be directly connected to the service tenancy, which may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example create, read, update, or delete (CRUD) operations, through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both of which may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage, which may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy, which may be isolated from the public Internet.

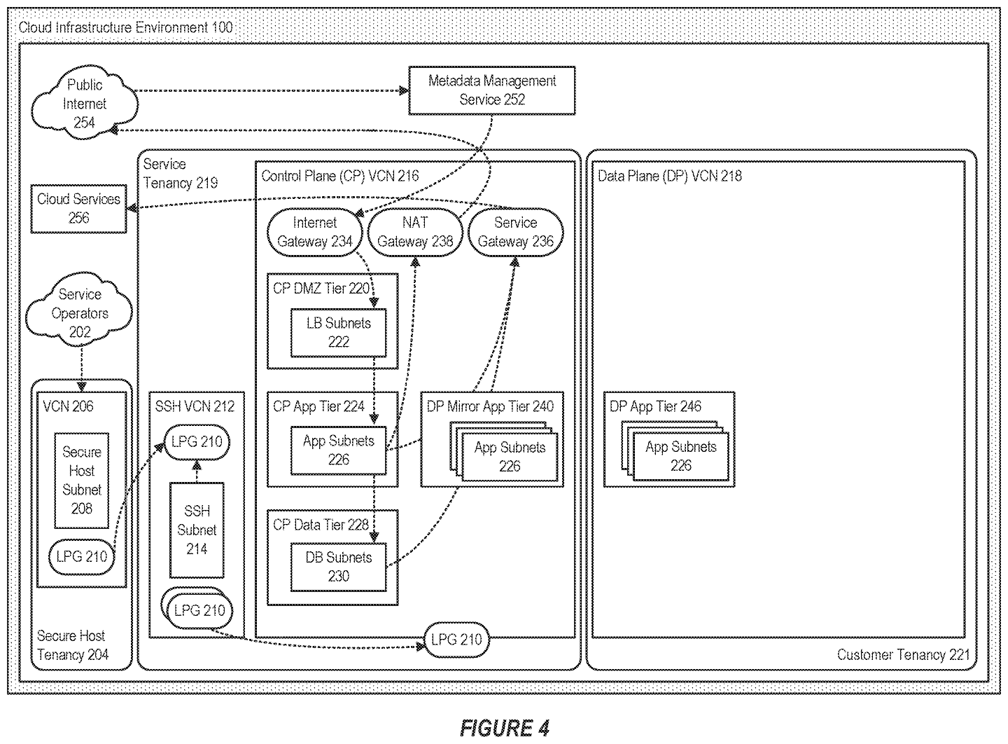

FIG. 4 illustrates another example of a cloud infrastructure architecture, in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources that are provisioned in the control plane VCN that is contained in the service tenancy, to be deployed or otherwise used in the data plane VCN that is contained in the customer tenancy.

In accordance with an embodiment, a customer of the cloud infrastructure provider may have databases that are managed and operate within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, of the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with Deployment 1 in Region 2.

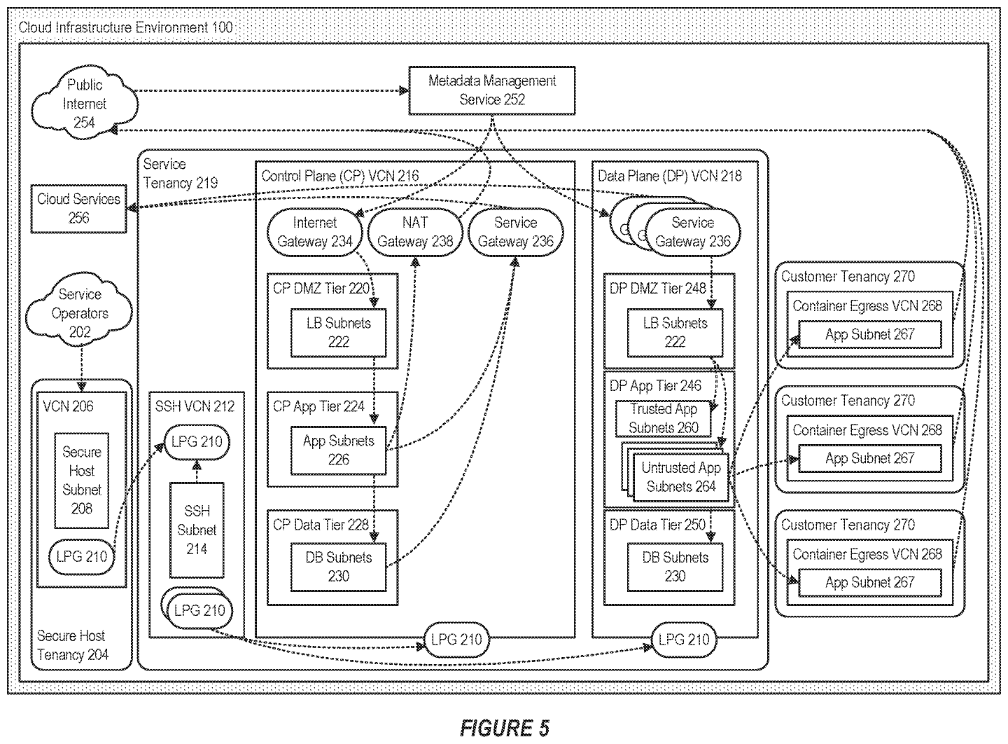

FIG. 5 illustrates another example of a cloud infrastructure architecture, in accordance with an embodiment.

As illustrated in FIG. 5, in accordance with an embodiment, the trusted app subnet(s) 260 can be communicatively coupled to the service gateway contained in the data plane VCN, the NAT gateway contained in the data plane VCN, and DB subnet(s) contained in the data plane data tier. The untrusted app subnet(s) 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs, and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)), which may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s), and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled; or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

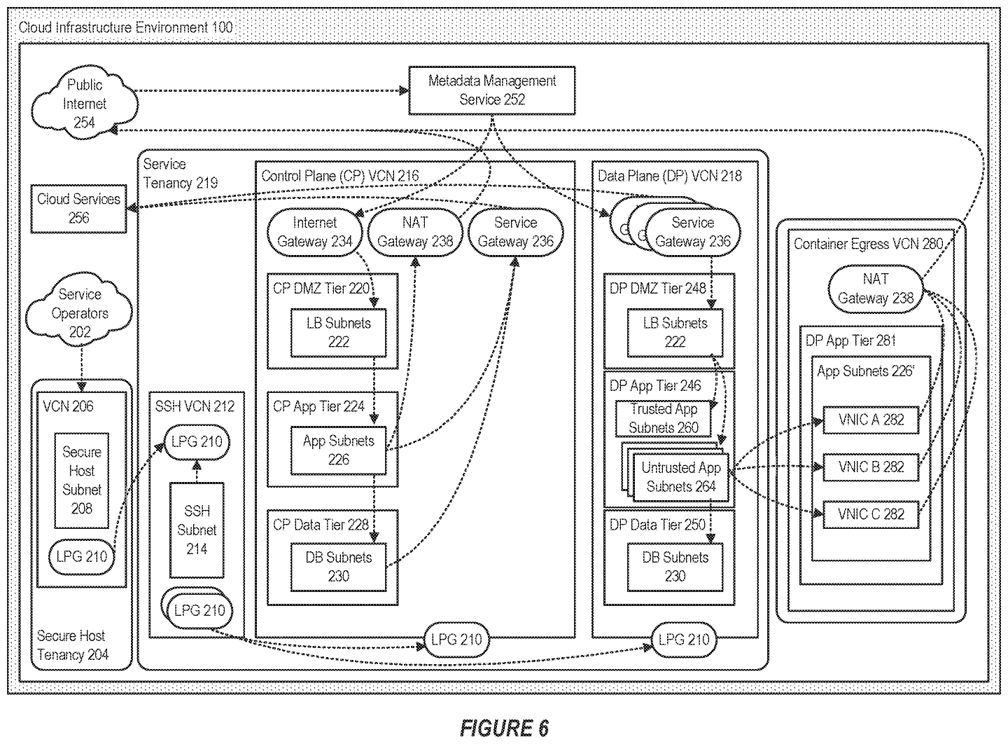

FIG. 6 illustrates another example of a cloud infrastructure architecture, in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container, and be communicatively coupled to an app subnet that can be contained in a data plane app tier 281 that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that requests a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Cloud Environments

In accordance with an embodiment, a cloud infrastructure environment can be used to provide dedicated cloud environments, for example as one or more private label cloud environments, for use by tenants of the cloud infrastructure environment in accessing subscription-based software products, services, or other offerings associated with the cloud infrastructure environment.

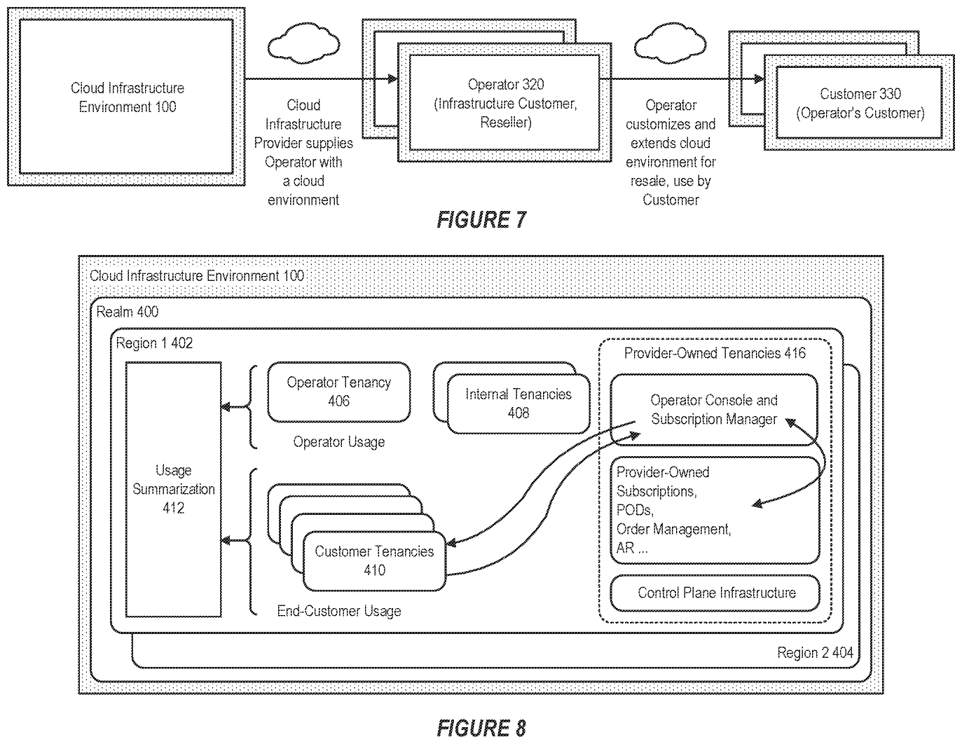

FIG. 7 illustrates how the system can provide dedicated or private label cloud environments, for use by tenants or customers of a cloud infrastructure environment, in accordance with an embodiment.

Although several of the examples described herein illustrate various systems, methods, and/or techniques as may be used in the context of providing private label cloud (PLC) environments, in accordance with various embodiments, the systems, methods, and techniques described herein can be used, within or with other types of cloud environments.

As illustrated in FIG. 7, in accordance with an embodiment, a cloud infrastructure provider can supply an operator 320, for example a cloud infrastructure customer operating as a reseller, with one or more cloud environments (e.g., a PLC environment) or realms. The operator/reseller can then customize and extend the cloud environment for use by (their) customer 330, for use in accessing subscription-based software products, services, or other offerings associated with the cloud infrastructure environment.

For purposes of illustration, examples of such subscription-based products, services, or other offerings may include various cloud infrastructure software products, such as Oracle Fusion Applications products, or other types of products or services that allow customers to subscribe to usage of those products or services.

FIG. 8 further illustrates the use of cloud realms, for use by tenants or customers of a cloud infrastructure environment, in accordance with an embodiment.

As illustrated in FIG. 8, in accordance with an embodiment, the system can include a cloud subscription service or component, referred to herein in some embodiments as a subscription manager, that exposes one or more subscription management APIs for creating orders used to onboard new customers, or to launch a workflow that creates a subscription and orchestrates billing and pricing service or other components for use with a cloud realm 400.

In accordance with an embodiment, when an operator (e.g., a PLC operator) or their customer requests a cloud environment, the system creates a realm, for use within a region 402, 404; together with one or more provider-owned tenancies 416. These tenancies allow a region to function with its required service infrastructure; and are administered by the cloud infrastructure provider.

In accordance with an embodiment, a first step in the process is to create an operator tenancy 406 for the operator, before the region and associated realms are turned over to them for subsequent management. The operator then becomes the administrator of this tenancy, within which they can view and manage everything that happens within that region, including their customer accounts and usage 412 by those customers of cloud resources.

Generally, once the region has been turned over or provided to the operator, the cloud infrastructure provider cannot subsequently access the data within the operator tenancy, unless the operator authorizes the cloud infrastructure provider to do so, for example to provide troubleshooting of issues that may arise.

In accordance with an embodiment, the operator can then create additional internal tenancies 408, intended for their own use internally, for example to assess what the end user or customer experience will be, or to provide a sales demo tenancy, or to operate a database for their own internal use. The operator can also create one or more customer tenancies 410, of which the end user or customer will be the administrator. Cloud infrastructure usage, for example compute, storage, and other infrastructure resources, is consolidated by operator, reflecting both their usage and that of their customers, and reported to the cloud infrastructure provider.

In accordance with an embodiment, a user interface or console can be provided that allows the operator to manage its customer accounts and customer-offered services. A cloud infrastructure provider can also use a cloud infrastructure tenancy, for example a Fusion Applications tenancy, to install any needed infrastructure services for use by the operator and their customers.

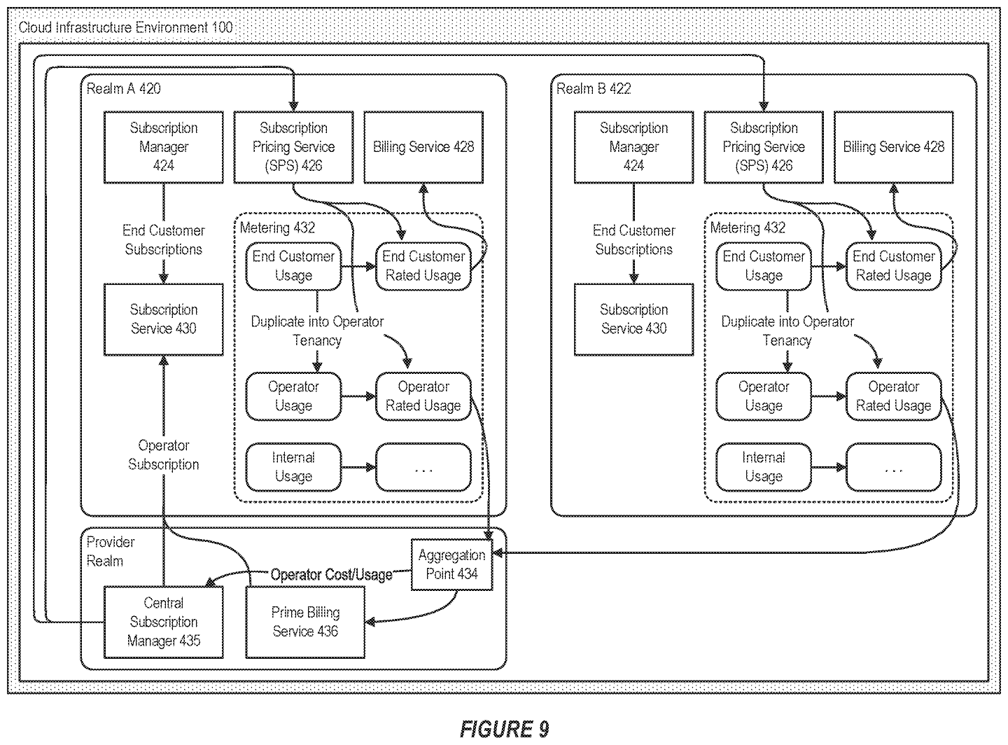

FIG. 9 further illustrates the use of cloud realms, for use by tenants or customers of a cloud infrastructure environment, in accordance with an embodiment.

As illustrated in FIG. 9, in accordance with an embodiment, a subscription manager 424 service or component exposes one or more subscription management APIs for creating orders used to onboard new customers, or to launch a workflow that creates a subscription and orchestrates billing and pricing service or other components.

In accordance with an embodiment, the system can also include a billing service 428 or component that operates upon a billing account or logical container of subscriptions and preferences used to produce an invoice for a customer.

In accordance with an embodiment, the system can also include a subscription pricing service (SPS) 426 or component, which operates upon a product catalog that defines which products can be purchased by a customer, and can be used to provide a price list (e.g., a rate card) that the pricing service also owns.

In accordance with an embodiment, to support the sales process through which a subscription is created in a realm 420, 422, products can be selected from a product hub. Once an order is created via a subscription service 430, a subscription is created in the subscription manager which thereafter manages the life cycle of that subscription, and provisions what needs to be provisioned in downstream services. The SPS component then manages the aspects of pricing and usage, for use in charging the end cost to the operator or their ability to charge their customers. Usage events are forwarded to the billing service or component, where depending on the billing preferences of the subscription, invoices are created and pushed to an accounts receivables component.

In accordance with an embodiment, although the services that are offered in a realm report their usage to a metering service or component 432, such usage does not have any price associated with it. A rating process determines how much each specific event costs, for example by applying rate cards, determines a unit and cost for that subscription, associates the cost to that record, and then forwards that to the billing service or component.

As further illustrated in FIG. 9, in accordance with an embodiment, an operator may control multiple realms A, B-for example an operator that operates in multiple countries may wish to operate a data center that is completely isolated for the United States of America, and a separate data center that is completely isolated for Europe, for example to address governance or regulatory requirements. In accordance with an embodiment, the usage associated with these multiple realms can be aggregated 434, for use by a central subscription manager 435, and where applicable a prime billing service 436, in billing the operator.

The examples of various systems illustrated above are provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Cloud Subscriptions

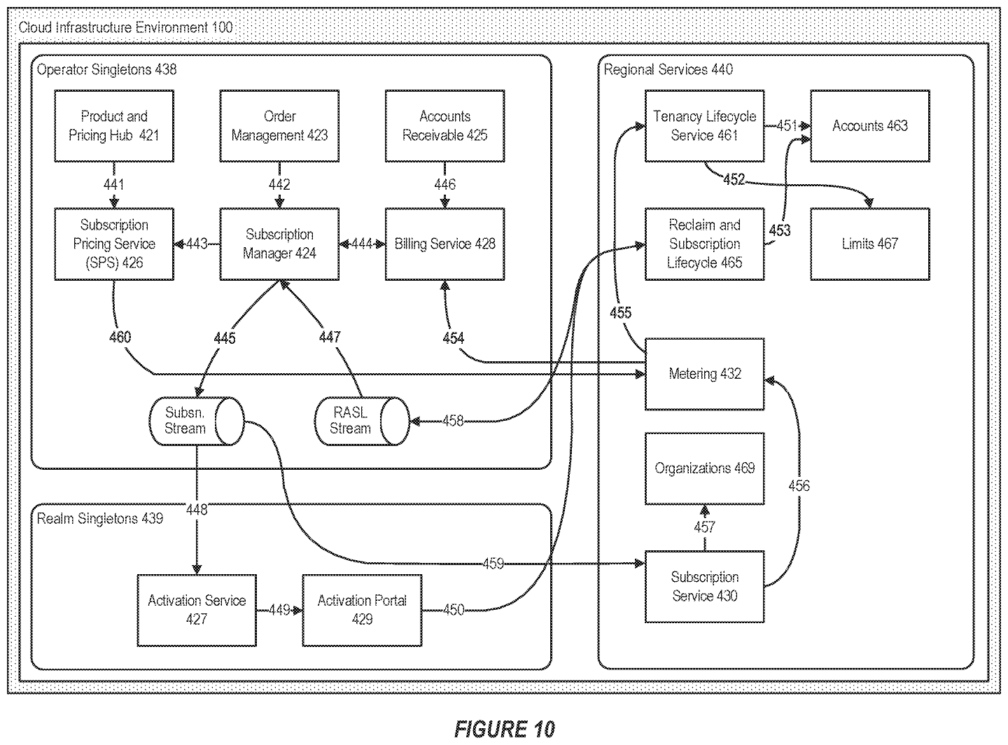

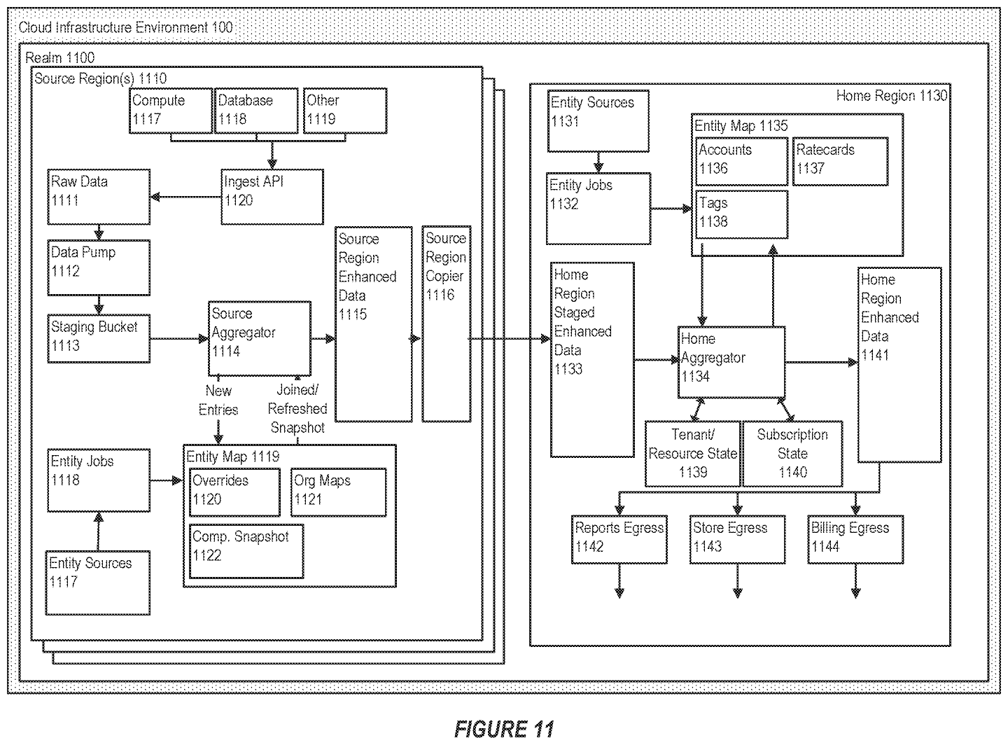

FIG. 10 illustrates a system for providing access to software products or services in a cloud computing or other computing environment, in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various cloud infrastructure software products or services that allow customers to subscribe to usage of those products or services.

In accordance with an embodiment, the environment can include a plurality of components provided as operator singletons 438, realm singletons 439, and regional services 440, as further described below.

In accordance with an embodiment, a subscription can include artifacts such as, for example, products, commits, billing model, and state. The subscription manager service or component can expose one or more subscription management APIs for creating orders used to onboard new customers, or to launch a workflow that creates a subscription and orchestrates creating the proper footprints in billing and pricing service or components, as further described below.

In accordance with an embodiment, the billing service or component operates upon a billing account or logical container of subscriptions and preferences used to produce an invoice. Each billing account generates one invoice per billing cycle. The billing service includes a first pipeline that accepts usage and cost from a metering service or component through a REST API, wherein billing writes the usage to a database from which billing workers aggregate and calculate balances; and a second pipeline responsible for taking the aggregated usage and commitments and calculating charges over a billing interval.

In accordance with an embodiment, the subscription pricing service (SPS) 426 or component operates upon a product catalog that defines which products can be purchased by a customer. The product catalog forms the backbone of a price list (i.e., rate card) that the pricing service also owns. Rate cards are modeled as pricing rules on top of public list prices. The pricing service maintains a single price list for all products, new product prices can be added, and existing prices changed. The price list has a full history, the latest version being the current rate card. Since some contracts may require a snapshot of the rate card be taken, the pricing service handles this by recording the time a customer's rate card is created, and then querying the price list at that time.

In accordance with an embodiment, the SPS or pricing service is responsible for communicating with a product and pricing hub 421, to provide information about products, global price list, and end user or customer's subscription specific price lists and discounts. For example, in accordance with an embodiment, SPS can synchronize product information from a product hub, and a global price list from a pricing hub.

In accordance with an embodiment, the subscription manager service or component operates as an upstream service to receive new order requests from an order management 423 component, for example from an Oracle Fusion Order Management environment. The subscription manager service or component can provide subscription information to the SPS service, including subscription details such as time of quote configured, or subscription type (Commitment, PayG), to help SPS to determine an effective base price (Rate Card) for the subscription. The subscription manager service or component can also send discounts for subscriptions received from the order management component, which SPS stores as a pricing rule entity.

In accordance with an embodiment, the SPS service runs as a background process to manage a rate cards service or component, which is responsible for generating rate cards for new subscriptions and updating those rate cards when new price changes occur. The SPS service can provide APIs to access rate cards and pricing rules. A metering in-line rating engine can utilize these APIs to obtain subscription-specific rate cards and pricing rules, and then use this data for cost calculations.

In accordance with an embodiment, additional SPS components can include, for example, a pricing/product hub integration component, that allows an operator entity providing subscription-based products, services, or other offerings within the environment, to manage their product and price list, for example as provided by a product hub and pricing hub respectively.

For example, in accordance with such an embodiment, an SPS product integration flow can listen to create/update events in the product hub and make calls to an SPS product API. Similarly, an SPS pricing integration flow can pull new price list creation from the pricing hub and call respective SPS pricing APIs.

In accordance with an embodiment, the system can also include an SPS core module that provides APIs to manage and access pricing entities. Pricing entities can be accessed by internal services, for example an inline rating engine.

In accordance with an embodiment, the system can also include a rate card manager component. The SPS service maintains the single base price for a product at a given time. However, product prices for subscription are dependent on a base price at quote configuration time and price list change policy attributes of subscriptions. The SPS service internally maintains the price to be used for subscription using these properties. All such price lists are grouped in a rate card. The rate card manager can create and maintain the rate card, listen to price list changes and update existing rate cards with the new price, and listen to new subscriptions and assigns the rate card based on subscription properties.

In accordance with an embodiment, the SPS service is responsible for managing pricing rules for a subscription, including discounts offered to an end user or customer. Pricing rules eligibility can be based on attributes of products, such as discount group, product category or specific SKUs. Internally SPS needs to identify the list of products for which these rules will be applicable. To accomplish this, a rule decoder engine can compile the pricing rules in a format such that an in-line rating engine can consume the information for cost calculation. This compilation process can be triggered when products or pricing rules are created or updated.

As illustrated by way of example in FIG. 10, in accordance with an embodiment: at 441, a product and price information managed in, e.g., Fusion Applications, is sent to the SPS component.

At 442, orders are sent to the subscription manager component to create subscriptions, rate cards and billing accounts.

At 443, pricing configuration and pricing rules are sent to SPS for new orders.

At 444, the subscription manager component is used to set up a billing account in the billing service or component.

At 445, the subscription manager component publishes events to an subscription manager streaming component.

At 446, a charge data is sent to an accounts receivable component 425 to generate invoices.

At 447, the subscription manager component consumes reclaim and subscription lifecycle (RASL) events from subscription manager streaming.

At 448, an activation service 427 reads the subscription manager event stream.

At 449, a customer obtains activation data from an activation portal 429.

At 450, a tenancy lifecycle service 461 provisions a tenancy as part of the subscription activation.

At 451, the tenancy lifecycle service creates, within an accounts 463 component, an accounts footprint during account provisioning.

At 452, the tenancy lifecycle service sets, within a limits service 467, a limits template during account provisioning.

At 453, the accounts component acts as a downstream RASL client to handle a legacy reclamation and subscription lifecycle 465.

At 454, aggregated cost and usage is sent to the billing service 428 or component.

At 455, an organization can create child tenancies using the tenancy lifecycle service.

At 456, a metering service 432 or component obtains subscription mapping data.

At 457, the subscription service 430 obtains organization data 469 for subscription mappings.

At 458, the RASL component reads the subscription manager event stream.

At 459, the subscription service reads the subscription manager event stream; and at 460, the metering service or component obtains a rate card data for each subscription, which can then be used in charging the end cost to the operator or their ability to charge their customers.

The above examples are provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Enriching Cloud Usage Data

With some subscription plan management (SPM) cloud service systems, service teams generate regularly occurring reports on usage of cloud resources by customers. The cloud resources may be grouped in compartments of the cloud service system that are accessible by designated customers associated with those compartments. The compartments define boundaries that may contain computer resources, database resources, block volume resources, and any other tools or services that might be made available by the cloud host to their customers associated with their respective compartments.

With such an approach however, the regularly occurring usage reports from the service teams typically include only rudimentary information relating to the particular resources that were used including information on the resource type, the compartment in which the resource resides, and the time of use of the resource.

In performing cost computations, for example as used in eventually billing the customers for the use of the resources, an auxiliary “enrichment data” can be used to enrich the raw usage data. The enrichment data is fetched in-line with the enrichment processing. The system can aggregate the numerous service team reports at regularly spaced-apart time intervals, such as once per hour (a “metering hour”) for example, and then supplement the aggregated data with other metadata that is more specific to the cost computations underlying the subscriptions for the use of the resources.

The metadata that is applied to the aggregated usage data may include information relating particular customers to particular resource containers, and other information relating the containers to particular subscriptions for billing purposes. Additional enrichment metadata may further be applied including information relating to possible subscription cost overrides such as mark-ups and/or mark-downs for making contractual cost and other adjustments to the rudimentary data comprising the service team reports.

Although the above approach requires considerable processing time, the method produces adequate technical results because it provides consistent enrichment of the raw usage data reported by the service teams by virtue of applying a set of supplemental metadata as it exists or that was otherwise available at the end of each metering hour to the resource usage data that was aggregated for that usage hour. Although the supplemental enrichment metadata might change during any given metering hour, such a system applied the metadata as it exists at the end of each metering hour.

In accordance with an embodiment, the described systems and methods can reduce the end-to-end latency of the overall process, negating or removing several steps that negatively contribute to the end-to-end latency, including the collecting of the usage data from the service teams at the metering hour intervals, the collecting of the metadata to be associated with the collected usage data, the enriching of the usage data with the proper metadata, the pricing of the usage, and then the step of ultimately preparing an invoice based on the priced usage. Such reductions and enhancements can greatly reduce processing time and improve computational efficiency of the system.

In accordance with an embodiment, the presently disclosed systems and methods reduce end-to-end latency between the customer's actual use of a resource and an invoice being sent to the customer through a number of steps.

In some embodiments, the systems and methods de-serialize the processing and instead process the usage data immediately as it is streamed from the service teams by joining the customer raw resource usage data with entities comprising small metadata units representative of historic time series enrichment data stored in one or more pre-configured dataset framework(s). Such dataset frameworks can be referred to herein as “entity maps”. The metering hour aggregation scheme used in previous subscription plan management system is not required. Instead, the processing of the cloud service system resource usage data is begun as soon as it is received, e.g., from the service teams.

In accordance with an embodiment, the entity maps can comprise small metadata units, which can be referred to as “entities”. The entities comprising the small metadata units stored in the entity maps can be utilized to ensure that the raw resource usage data received from the service teams is properly enriched by joining the usage data with metadata units contained in the entity maps having time windows associated therewith that match the times of the use of the resources as indicated in the raw usage data. In this way the metadata units comprising time series enrichment data contained in the entity map datasets may be used to process the raw resource usage data regardless of when it is reported, e.g., by the service teams, and may be processed immediately as they are received by various metering and other components of the overall system.

In accordance with an embodiment, entity map datasets can be built or configured in a way that they are ready to be joined with the raw usage data using a data processing engine as the usage data is streamed to the system from the service teams. The entity map datasets can maintain a time-series data for non-time-series resource usage data sources and represent historic time series data. In addition, the single entity framework provided by several entity map datasets may be used to process data from multiple sources in the same way. These attributes ensure consistent behavior across all usage data, including usage data arriving late from the service teams, as well as usage data that is received from the service teams out-of-order.

In accordance with an embodiment, each entity map can comprise a key column that holds a representation of a type of the entity map, a value column that holds a property payload used to enrich one or more appropriate portion(s) of the resource usage data, a column holding a start timestamp payload representative of the start time of a value freshness time window (also referred to herein as “effective_start_ts”), and a column holding an end timestamp payload representative of the end time of the value freshness time window (also referred to herein as “effective_end_ts).

In accordance with an embodiment, entity maps may be refreshed periodically. In the case where there are no changes to the value column payload during the refresh period, the refreshing comprises simply incrementing the payload in the effective_end_ts column to hold an end timestamp payload that is representative of an end time of the value freshness time window in the future.

An example is to increment the end timestamp payload one (1) hour, thereby extending the value freshness time window by one (1) hour into the future. When there are changes to the value column payload during the refresh period, the refreshing comprises permitting the current key/value pair to expire with the existing effective_end_ts, and opening a new window row for a new key/value pair that has in its effective_start_ts column the previous end timestamp payload, and that has in its effective_end_ts column an end timestamp payload representative of the previous end timestamp payload incremented by one (1) hour thereby defining a new value freshness time window of the new value payload that begins at the expiration of the previous value freshness time window and that extends one (1) hour into the future.

In accordance with an embodiment, entity maps can comprise semi-immutable datasets, in that new/additional value and time payloads are only added to the entity maps; while the value or time payloads that already exist in an entity map cannot be modified or deleted. The metadata unit entries of the entity map can be treated as being immutable once stored, wherein the entity map itself is modifiable overall, but only by the addition of new metadata unit entries at the end of the current date/time range. The entity map may only be changed or otherwise modified by appending information such as for example by adding further metadata unit entries.

In this sense, the entity maps are “rolling” data structures applicable for both current and past resource usage. This attribute of entity maps ensures consistent behavior across all resource usage data, including usage data arriving late from the service teams, as well as usage data that is received from the service teams out-of-order.

In accordance with an embodiment, the processing of the resource usage data comprises receiving streamed usage data and consulting the entity map based on the metering time of the usage data to determine the effective metadata/entity for this resource usage at the time the usage occurred. Entity map lookup requires locating the time window row corresponding the resource usage timestamp and then applying the value column payload of that row to the streaming usage data such as by using a join function of a data processing engine. The entity map can be maintained as part of a pipeline processing of the metering component so that when processing the usage data is needed, a function (such as a JOIN function) into the entity map need only be performed, without any delays in the usage processing.

FIG. 11 illustrates a system for supporting enriching cloud usage data, in accordance with an embodiment.

As illustrated in FIG. 11, in accordance with an embodiment, within a cloud infrastructure environment 100 there can be deployed or provided a realm 1100, where the realm can represent a boundary within the cloud infrastructure environment. Such a realm boundary can be defined, for example, in the context of an operator (e.g., a PLC operator) of the cloud infrastructure environment.

Although several of the examples described herein illustrate various systems, methods, and/or techniques as may be used in the context of providing private label cloud (PLC) environments, in accordance with various embodiments, the systems, methods, and techniques described herein can be used, within or with other types of cloud environments.

In accordance with an embodiment, within the realm there can be various regions of the realm, including source region(s) 1110, as well as a home region 1130. The regions can represent groupings of resources, such as geographic groupings of computer hardware.

In accordance with an embodiment, a home region can be defined, for example, upon designation by an authorized user of, for example, an operator (e.g., PLC operator). It should be noted that, while shown as multiple regions within FIG. 11, a source region and a home region can be the same region in situations where, for example, an operator (e.g., PLC operator) has only one region defined within the realm.

In accordance with an embodiment, raw data 1111 can be reported as being utilized within a source region. Such raw data can comprise an input from an ingestion API 1120 that receives data indicative of usage of resources of the cloud computing environment, such as compute resources 1117, database resources 1118, as well as all other resources 1119. All of such usage can be delivered to/fetched by the ingestion API 1120, which can in turn translate such usage of resources into a stream of raw data 1111.

In accordance with an embodiment, a component operating as a data pump can be used to break the streams of raw data up into discrete sections of data. In an embodiment, for example, a stream of raw data 1111 can be broken into a configurable number of minutes (e.g., 5 minute) sections, which can then be stored at a staging bucket 1113 by the data pump.

In accordance with an embodiment, the data pump 1112 can comprise a substrate service or an overlay service that egresses data out of ingest database to object store as files. To keep the extract simple and idempotent, the data pump can utilize a process (an example of which displayed below as a pseudocode) as a watermark. A chunk size, which can be configurable, can be picked to maintain a desired end-to-end latency.

For example, a 5 minute chunk size can be set to maintain a 1 hour end to end latency, but this chunk size can be configured to be, for example, 10 or 15 minutes without changing any of the downstream components since this is a buffer mechanism.

select * from bling_ingest.INGEST_STREAM_PARTITIONED
where created_on >= :1 and
created_on <:2 -- 10/01 15:20 to 10/01 15:25
dumped as 20221001_1520-5.filetype

In accordance with an embodiment, an auto-incremented identification can be used for watermarking, both columns (ID and created_on) have the risk of being committed out of order so the system can specify an amount of time, e.g., a 4 minute buffer, for transactions to settle.

In accordance with an embodiment, the data pump can comprise a service that can be deployed to multiple hosts for redundancy. A singleton of the service can be provided per region and also store the watermark part of the singleton service.

In accordance with an embodiment, the chunks of raw data as produced by the data pump and stored at the staging bucket 1113 can be read by the source aggregator 1114. The source aggregator, based an initial metadata associated with/carried by the raw usage data, can interact with an entity map 1119 to perform a join operation with the raw usage data to enhance the metadata associated with/carried by the raw usage data.

In accordance with an embodiment, as an example, the raw usage data can be associated with/carry metadata prior to being joined with additional metadata at the source aggregator. Such initial metadata can comprise, for example, a compartment ID identifying a compartment at which the usage occurred, a resource ID identifying the resource associated with the usage, service meter (hour) value identifying a time duration of usage of the resource, and resource tags.

In accordance with an embodiment, in utilizing the entity map 1119, the source aggregator can join additional data/metadata to the raw usage data using entities stored at the entity map. Such entities can include, for example, overrides 1120, organization maps 1121, compartment snapshots 1122, and more.

In accordance with an embodiment, such an enrichment step can comprise a join or a map lookup with pre-built entity maps and additional attributes are picked up. An example pseudo code for an exemplary join operation is provided below. Custom enrichments can also be supported by utilizing map operations to populate custom attributes.

```
usage.alias(“u”).join(compartmentMap.alias(“c”),
expr(“u.compartment_id = c.compartment_id and
  u.start_ts between c.effective_start_ts and
  c.effective_end_ts”), “left”)
```

In accordance with an embodiment, a generic schema for an entity map is represented below and shown as a key-value pairing. The value column can generally be a complex type that has a bunches properties associated with an entity represented by the key, and this mapping is valid for interval between effective_start_ts and effective_end_t:

```
key - something representing an entity
value (json/binary) - complex type that provides a bunch of
  properties on the entity
effective_start_ts - map validity (start inclusive),
  represented as epoch millis
effective_end_ts - map validity (end exclusive),
  represented as epoch millis
created_ts - for auditing
updated_ts - for auditing
```

In accordance with an embodiment, entity maps can comprise semi-immutable datasets, in that new/additional value and time payloads are only added to the entity maps; while the value or time payloads that already exist in an entity map cannot be modified or deleted. The metadata unit entries of the entity map can be treated as being immutable once stored, wherein the entity map itself is modifiable overall, but only by the addition of new metadata unit entries at the end of the current date/time range. The entity map may only be changed or otherwise modified by appending information such as for example by adding further metadata unit entries.

This attribute of entity maps ensures consistent behavior across all resource usage data including usage data arriving late from the service teams as well as usage data that is received from the service teams out-of-order.

In accordance with an embodiment, for example, the entity map can comprise a mapping of compartment ID to tenancy IDs. In such a way then, a join operation can enrich the raw usage data with a tenancy ID associated with the usage data.

In accordance with an embodiment, the source aggregator together with the entity map are used to enrich and apply updates on the raw usage data (e.g., usage data reported by the service teams). In order to perform this enrichment, entity map datasets can be pre-built and ready to be joined with the raw usage data. Pulling data from the actual source per usage record is not scalable. To standardize the consumption of these entity maps and to ensure consistent behavior across out-of-order/late-arriving data, the entity maps can be pre-built.

In accordance with an embodiment, an entity map can comprise various entities for enrichment of raw usage data, for example: subscription metadata (source is subscription service—pull model), accounts metadata (source is accounts service—pull model or an API for pulling updates—since, can be used for delta refresh), metering definition (provided by metering, updated e.g., by service teams), compartment metadata (source can be an identity provider—pull model), rate cards and discounts (source is billing service—pull updates model).

In accordance with an embodiment, the entity sources 1117 and entity jobs 1118 can be used to add to or update an entity map.

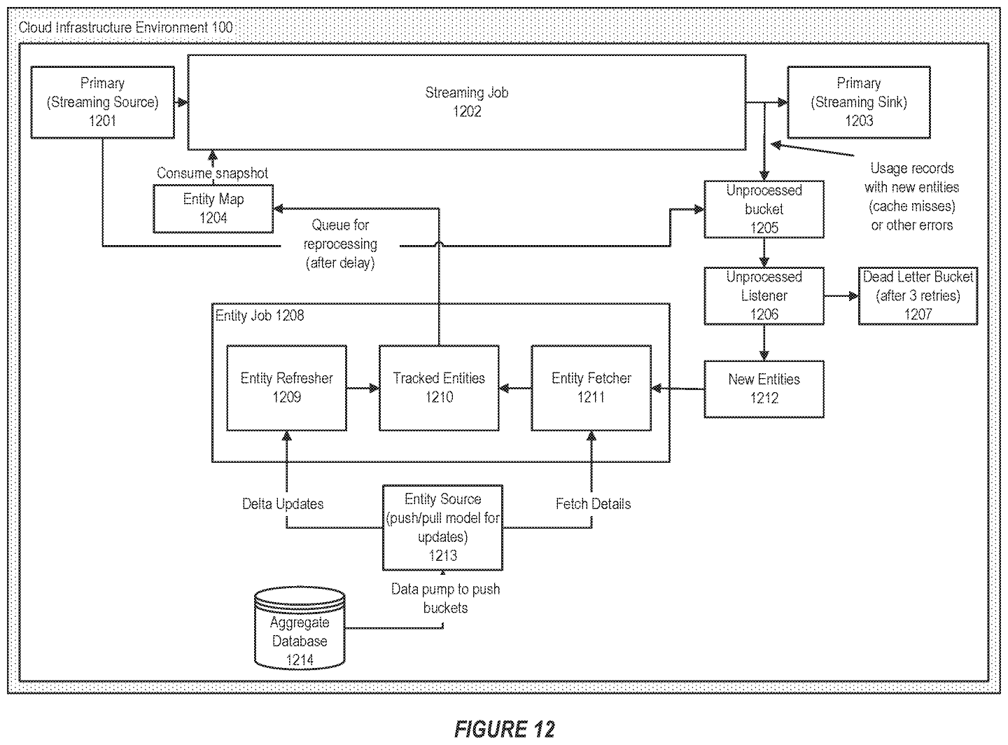

For example, if a value of a key changes after a certain time period during which it was previously valid, then the entity sources and entity jobs can be used to add to or append an entry within the entity map 1119. Such updating of the entity map is discussed further in conjunction with FIG. 12.

In accordance with an embodiment, once the source aggregator has enriched the raw usage data (i.e., the chunks of raw usage data) by performing a join operator on the raw usage data from the entity map, the enriched usage data can be pushed/stored at source region enhanced data 1115. The source region copier 1116 can fetch such enhanced data, and based upon the data enrichments, transfer the data to a correct home region.

For example, as part of the data enrichment process at the source aggregator, along with tenancy information being added to the raw usage data, organization data about a tenant may also be enriched to the raw usage data, where such organization data may comprise a home compartment of the tenant or the tenant's organization. In this way, the source region copier can maintain a number of outboxes, each outbox corresponding to a home region to which it can copy/transfer the enriched raw usage data.

In accordance with an embodiment, in situations where tenant usage for a tenant is required to be hosted in the home region, usage from all source regions (where usage happens) can be copied over to the home region of the tenant and further processing like hourly aggregation and cost computation happens at the home region of the tenant. This routing/copy function is performed by the source region copier 1116, which can comprise a singleton instance per source region, that polls for new artifacts generated in the source region and triggers an object store copy request, and tracks the request to closure. This service does not perform any download/upload operation simply sends instructions object store to replicate objects.

In accordance with an embodiment, at the home region 1130, the data enriched by the source aggregation can be received at the home region staged enhanced data 1133. From there, the home aggregator can interact with an entity map 1135 to perform a join operation with the enriched data to further enhance the metadata associated with/carried by the raw usage data.

In accordance with an embodiment, as an example, in utilizing the entity map 1135, the home aggregator can join additional data/metadata to the enhanced data (already enhanced at the source aggregator) using entities stored at the entity map 1135. Such entities can include, for example, accounts 1136, rate cards 1137, tags 1138, and more.

In accordance with an embodiment, a generic schema for an entity map 1135 is represented can be provided as key-value pairing, as illustrated above; wherein the value column can generally be a complex type that has a bunches properties associated with an entity represented by the key and the mapping is valid for interval between effective_start_ts and effective_end_t.

In accordance with an embodiment, the entity map 1135 can comprise semi-immutable datasets, in that new/additional value and time payloads are only added to the entity maps; while the value or time payloads that already exist in an entity map cannot be modified or deleted. The metadata unit entries of the entity map can be treated as being immutable once stored, wherein the entity map itself is modifiable overall, but only by the addition of new metadata unit entries at the end of the current date/time range. The entity map may only be changed or otherwise modified by appending information such as for example by adding further metadata unit entries.

In accordance with an embodiment, for example, the entity map can comprise a mapping of rate cards to tenancies. In such a way, then, a join operation can enrich the previously enriched usage data with a rate card ID associated with the tenancy information previously enriched to the usage data by the source aggregator.

In accordance with an embodiment, the source aggregator together with the entity map are used to enrich and apply updates on the raw usage data (e.g., usage data reported by the service teams). In order to perform this enrichment, entity map datasets can be pre-built and ready to be joined with the raw usage data. Pulling data from the actual source per usage record is not scalable. To standardize the consumption of these entity maps and to ensure consistent behavior across out-of-order/late-arriving data, the entity maps can be pre-built.

In accordance with an embodiment, an entity map can comprise various entities for enrichment of raw usage data, for example: subscription metadata (source is subscription service-pull model), accounts metadata (source is accounts service-pull model or an API for pulling updates-since, can be used for delta refresh), metering definition (provided by metering, updated e.g., by service teams), compartment metadata (source can be an identity provider-pull model), rate cards and discounts (source is billing service-pull updates model).

In accordance with an embodiment, the entity map can also support override entities. Such overrides can include, for example, static configurations for meter zonal overrides per region (provided by the entity map), service overrides (pushed to entity maps via an API), banking origin overrides (pushed to entity map via an API), tenancy resource overrides, and government SKU overrides.

In accordance with an embodiment, the entity map 1119 and the entity map 1135 can comprise the same entity map.

In accordance with an embodiment, the entity sources 1131 and entity jobs 1132 can be used to add to or update an entity map 1135.

For example, if a value of a key changes after a certain time period during which it was previously valid, then the entity sources and entity jobs can be used to add to or append an entry within the entity map 1135. Such updating of the entity map is discussed further in conjunction with FIG. 12.

In accordance with an embodiment, in enriching the data from the home region staged enhanced data 1133, the home aggregator can also interact with the tenant/resource state 1139 and the subscription state 1140.

In accordance with an embodiment, on enriching the data at the home aggregator, the further enriched data can be stored at the home region enhanced data 1141, from which it can be utilized in reports egress 1142, store egress 1143, or billing egress 1144.

In accordance with an embodiment, reports egress 1142 can be utilized for generating usage and cost reports, such as files that comprise usage data at the hourly granularity for all of the customer's resources.

In accordance with an embodiment, the store egress 1143 can be utilized to populate a usage storage database, which data can be pulled from to, for example, populate a console utilized by an operator of the cloud infrastructure environment. When an operator accesses their console, at least some of the data that drives this console experience is pushed from home aggregator to here.

In accordance with an embodiment, the billing egress 1144 can be utilized for determining how much a particular usage costs (e.g., based upon the usage data being enriched with a rate card), and billing then takes that and generates a bill.

In accordance with an embodiment, the described systems and methods above improve compute efficiency as the end to end (usage to reports/billing) is reduced by a significant amount. In some embodiments, the end to end usage to reports is reduced from 12 hours to one hour.

FIG. 12 is a diagram showing a method for consuming or updating an entity map, in accordance with an embodiment.

In accordance with an embodiment, FIG. 12 depicts a skeleton of an entity map job (e.g., spark job) that periodically refreshes entity maps based on updates from an entity source.

In accordance with an embodiment, a primary source 1201 can feed a streaming job 1202, which can load a latest entity map 1204 available at the beginning of each mini-batch and use the same to look up additional attributes. The streaming job can generate a primary output 1203 and store data to unprocessed bucket 1205 which failed the lookup. This unprocessed bucket 1205 will power the entity job 1208 to fetch for the new entities 1212, and an attempt will be made after a time period to process the same unprocessed bucket (e.g., from the primary source) and eventually, data get moved to the dead-letter bucket 1207 after a number of retries (e.g., 3 retries).

The retry delay mechanism can be based on an offset from a current batch identification. For example, when the systems and methods are processing batch X, the systems and methods can also load unprocessed data from batch X-offset and process it as if it came part of batch X and also increase the attempt count, which determines when data ends up in the dead-letter queue.

In accordance with an embodiment, the entity job 1208, via the unprocessed listener 1206 (e.g., EntityJob listener) listens to the unprocessed bucket to identify new entities 1212 and adds it, via the entity fetcher 1211, to the tracked entities 1210. The entity job then refreshes 1209 all entities that are due for a refresh, the source 1213 for the entity attributes refresh can be a push (an event stream) or a pull model. From the aggregate database 1214, the entity source can have a data pump.

In accordance with an embodiment, during a cold start, there can be a scenario where these jobs are deployed for the first time there, which can result in a circular dependency since streaming job 1202 and entity job 1208 needs each other's outputs. In such a situation, the streaming job can default the entity map to an empty dataset if no initial map is available and all the rows will have a join-miss and data gets stored to the unprocessed bucket. This unprocessed dump will trigger the entity job to process the new entities, and after a few batches amount of data going to the unprocessed bucket will taper off.

In accordance with an embodiment, alerts can be supported. Alerts can be triggered on both unprocessed (5%) and dead-letter buckets (0.01%). For unprocessed, new entities should show up here or when the entity source has an issue; for dead-letter, these could be invalid entities or entities missing in the entity source system.

In accordance with an embodiment, the systems and methods can additionally support automatic reprocessing of the unprocessed bucket (e.g., on a configurable interval, such as every 1 hour), and after 3 retries items would go to dead-letter. A dead-letter queue can be investigated once a week (when <0.01%) and escalated to entity source systems like Accounts/Subscriptions. Based on the outcome, the systems and methods may trigger a re-processing of this data.

In accordance with an embodiment, when a new entity is discovered by the entity job, the attributes are fetched and are added to the entity map with a start_ts as Oms (beginning of time) and end_ts as current time +1 hr rounded up to the hour.

In accordance with an embodiment, when refreshing entity attributes, entities that have expired or about to expire (e.g., in the next 30 minutes) can be picked up for refresh. Various actions can be performed on a refresh. If there are no changes to the value payload, then the effective_end_ts can be extended (e.g., to the next hour). If there are changes to a value payload, then the current key/value pair is left to expire with the existing effective_end_ts timestamp, and a new window is opened for the new key/value pair effective from the next hour.

In accordance with an embodiment, entity maps can be updated for future time windows, in-progress hour/day will not be updated, and effective time stamps can be rounded up to the hour for consistent behavior across different parts for the hour and late arriving data. Map misses can be stored to the unprocessed folder. A single rolling entity map can be applicable for both current and past usage. An exemplary lookup is provided below-most entities might just have one entry-if they have changes start_ts/end_ts will help pick the right row.

```
usage.entity_key = entity.key and
  (usage.metering_ts between entity.effective_start_ts
  and entity.effective_end_ts)
```

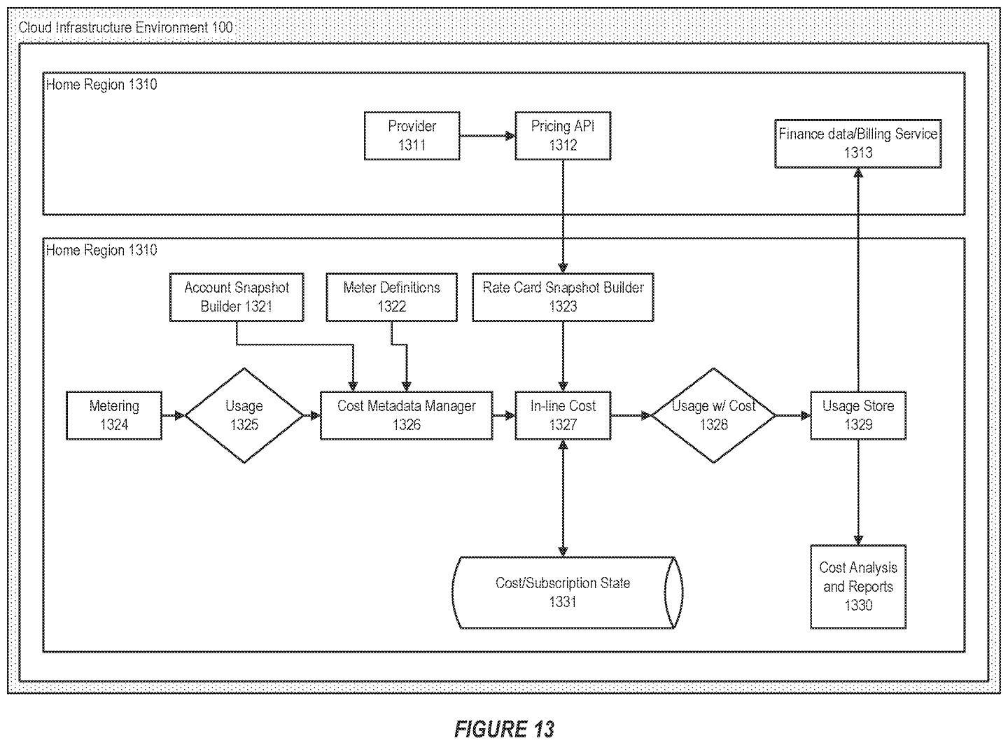

FIG. 13 is a diagram of cost computation, in accordance with an embodiment.

As illustrated in FIG. 13, in accordance with an embodiment, cost computation and billing can be performed in-line as opposed to out of band. Usage data chunks 1325, from metering 1324, can be grouped into mini-batches.

For example, in a steady state, each 5 minute window can comprise a mini-batch. Since this occurs after the copy to the home region 1310, the systems and methods can support 5 minute chunks, each, e.g., from an active source region. This usage data can be joined with the resource level state to generate billable usage from the actual usage based on rules, such as rounding rules for the meters.

In accordance with an embodiment, a cost metadata manager 1326 can pull data/metadata/definitions from account snapshot builder 1321 and meter definitions 1322. In-line cost 1327 can utilize the cost metadata manager, as well as looking up a cost/subscription state and utilizing information from the rate card snapshot builder, which can be based upon input from a provider 1311 to a pricing API 1312.

In accordance with an embodiment, in this way, usage data with cost 1328 is generated 1328, which can be stored at a usage store 1329, and further egressed to a finance data or billing service 1313, or used for generating cost analysis or other reports 1330.

In accordance with an embodiment, the systems and methods can join this usage with the resource level state to generate billable usage from the actual usage based on the rounding rules for the meters. Since it may not be possible to simply add the new 5 minutes usage to the total, since they may be associated with different hourly rounding rules associated with the meters, the system supports various features as described below.

In accordance with an embodiment, cost computation is the next step after the billable value calculation, this involves pulling a rate card based on the tenancy attributes on accounts and uses attributes from the subscription state to calculate the cost/charges from the usage. This can be a simple calculation of rate quantity, but in some cases like tiering and high-watermark SKUs, the subscription state information is used. Regarding making exactly once and consistent writes to different state stores, the systems and methods can use an idempotent write feature.

In accordance with an embodiment, the systems and method can provide for support for SKUs having variable rates. For some SKUs, the rate may not be fixed. There could be tiers—for example, having a tiering model where a first amount of data of block storage is free, but a rate applies to anything exceeding the first amount per month. The systems and methods can support such a model with any number of tiering ranges based on custom contracts.

In accordance with an embodiment, the systems and methods can also support high watermark SKUs. Instead of charging for the total usage, for some SKUs, the charge can be for a max usage within a time window which could be hour/month. Charges are the same usage for the entire window. However, this is performed on a rolling basis and cannot wait until the window is closed. The systems and methods provide support by storing the last high watermark and when any usage shoots beyond the watermark then the watermark is increased and the delta usage is charged for the remaining time in the window.

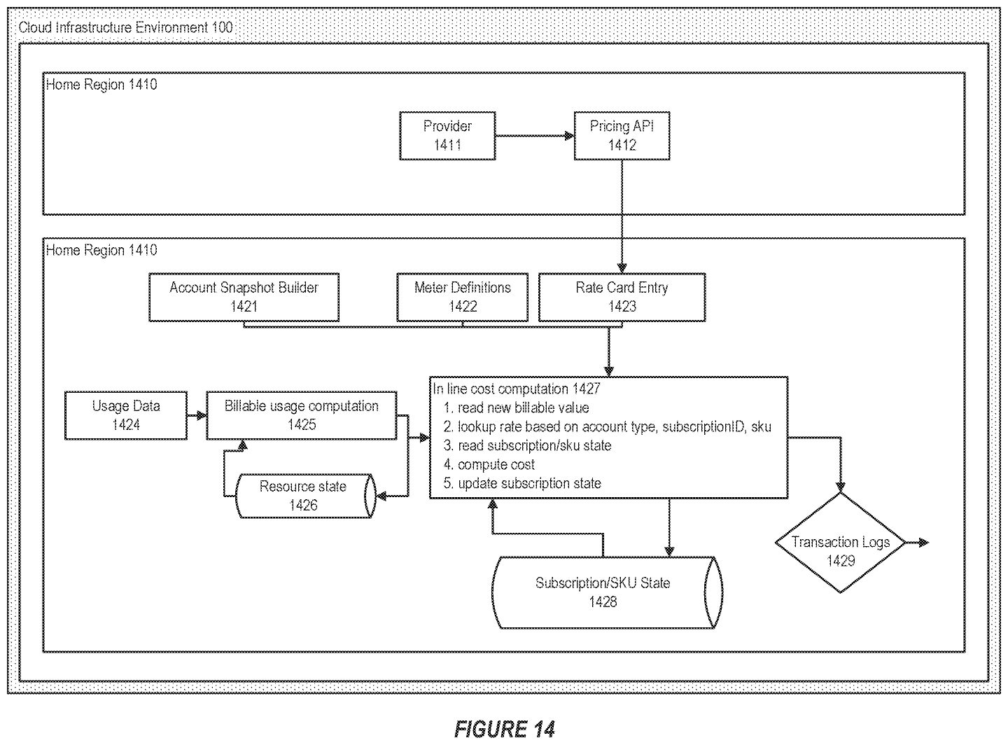

FIG. 14 is a diagram of cost computation, in accordance with an embodiment.

In accordance with an embodiment, more specifically, FIG. 14 shows in-line cost computation, which can occur in a home region 1410.

In accordance with an embodiment, in line cost computation can utilize usage data 1324, which can be grouped into mini-batches.

In accordance with an embodiment, a billable usage computation 1425 can write to and read from a resource state 1426 database. In line cost computation 1427 can utilize account snapshot builder 1421 and meter definitions 1422. In-line cost computation can additionally use rate card entries 1423, which can be based upon input from a provider 1411 to a pricing API 1412.

In accordance with an embodiment, in-line cost computation can comprise a number of steps, including, for example:
1. Read a new billable value. This can comprise loading pre-built entity maps, including accounts, metering definition and rate cards. As part of this, the systems and methods can also consume a billable usage.
2. Lookup rate based on account type, subscription ID, SKU . . . etc. This can comprise looking up monthly subscription state for SKUs that have monthly tiering or monthly high watermarks
   a. For tiered SKUs, the systems and methods can look up the running usage total for the calendar month to pick the correct tier/rate.
   b. For monthly high watermark SKUs, the systems and methods can fetch the current high watermark value to generate a delta cost if usage goes beyond the watermark.
3. Read subscription/SKU state 1428. This can comprise looking up a rate based on the account_type, subscription and SKU.
4. Compute the cost.
5. Update the subscription and resource states with the mini-batch id as the idempotency token to guarantee exactly-once update.

In accordance with an embodiment, the remaining egress processes downstream from cost computation can be based on the transaction logs 1429 based on the updates to the resource state.

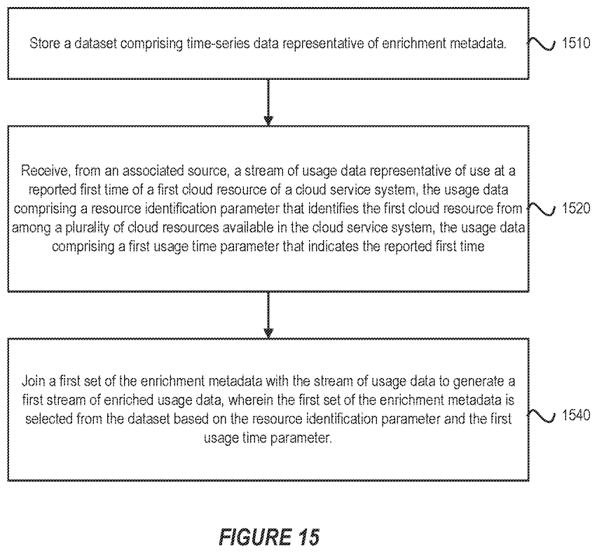

FIG. 15 is a flowchart a method for enriching cloud usage data, in accordance with an embodiment.

As illustrated in FIG. 15, in accordance with an embodiment, a method can be performed in a computer system including a processor device and a non-transitory memory device operatively coupled with the processor device.

In accordance with an embodiment, at step 1510, the method can store, in the non-transitory memory, a dataset comprising time-series data representative of enrichment metadata.

In accordance with an embodiment, at step 1520, the method can receive, from an associated source, a stream of usage data representative of use at a reported first time of a first cloud resource of a cloud service system, the usage data comprising a resource identification parameter that identifies the first cloud resource from among a plurality of cloud resources available in the cloud service system, the usage data comprising a first usage time parameter that indicates the reported first time.

In accordance with an embodiment, at step 1530, the method can join a first set of the enrichment metadata with the stream of usage data to generate a first stream of enriched usage data, wherein the first set of the enrichment metadata is selected from the dataset based on the resource identification parameter and the first usage time parameter.

In accordance with an embodiment, the first set of the enrichment metadata can be selected from the dataset based on determining the first usage time parameter to be within a first time window defined by the time-series data of the dataset.

In accordance with an embodiment, the method can further join a second set of the enrichment metadata with the first stream of enriched usage data to generate a second stream of enriched usage data, wherein the second set of the enrichment metadata is selected from the dataset based on the resource identification parameter and a second usage time parameter that indicates a reported second time of use of the first cloud resource.

In accordance with an embodiment, the selection of the second set of the enrichment metadata can further be based on determining the second usage time parameter to be within a second time window defined by the time-series data of the dataset.

In accordance with an embodiment, joining the first set of the enrichment metadata with the stream of usage data can comprise using a join operation of an associated data processing engine to associate the first set of the enrichment metadata with the stream of usage data.

In accordance with an embodiment, receiving the stream of usage data from the associated source can comprise: receiving a stream of usage data representative of the use at the reported time of the first cloud resource held in a first cloud boundary of the cloud service system available to an associated consumer processor device affiliated with the first cloud boundary, the stream of usage data comprising a boundary identification parameter that identifies the first cloud boundary holding the first cloud resource.

In accordance with an embodiment, joining the first set of the enrichment metadata with the stream of usage data to generate the first stream of enriched usage data can comprise generating the first stream of enriched usage data by joining the stream of usage data with a second set of the enrichment metadata selected from the dataset based on the resource identification parameter, the usage time parameter, and the boundary identification parameter.

In accordance with an embodiment, the method can further refresh the dataset by receiving updated value data representative of an updated value of an item of the enrichment metadata. As well, the method can further associate the updated value of the item of the enrichment metadata with an updated time window defined by updated time window data. The method can also store the updated value data in association with the updated time window data in the dataset by adding the updated value data and the updated time window data to the dataset as a new updated time-series data.

In accordance with an embodiment, the method can join the stream of usage data with a second set of enrichment metadata at the dataset to generate a second stream of enriched usage data, the second set of enrichment metadata comprising the updated value of an item of the enrichment metadata.

In accordance with an embodiment, the dataset can comprise an entity map dataset.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A method, comprising:
storing a dataset comprising time-series data representative of enrichment metadata;
receiving, from an associated source, a stream of usage data representative of use at a reported first time of a first cloud resource of a cloud service system,
the usage data comprising a resource identification parameter that identifies the first cloud resource from among a plurality of cloud resources available in the cloud service system,
the usage data comprising a first usage time parameter that indicates the reported first time; and
joining a first set of the enrichment metadata with the stream of usage data to generate a first stream of enriched usage data, wherein the first set of the enrichment metadata is selected from the dataset based on the resource identification parameter and the first usage time parameter.

2. The method of claim 1, wherein the first set of the enrichment metadata is selected from the dataset based on determining the first usage time parameter to be within a first time window defined by the time-series data of the dataset.

3. The method of claim 2, further comprising:
joining a second set of the enrichment metadata with the first stream of enriched usage data to generate a second stream of enriched usage data,
wherein the second set of the enrichment metadata is selected from the dataset based on the resource identification parameter and a second usage time parameter that indicates a reported second time of use of the first cloud resource.

4. The method of claim 3, wherein the selection of the second set of the enrichment metadata is further based on determining the second usage time parameter to be within a second time window defined by the time-series data of the dataset.

5. The method of claim 1, wherein joining the first set of the enrichment metadata with the stream of usage data comprises using a join operation of an associated data processing engine to associate the first set of the enrichment metadata with the stream of usage data.

6. The method of claim 1,
wherein receiving the stream of usage data from the associated source comprises:
receiving a stream of usage data representative of the use at the reported time of the first cloud resource held in a first cloud boundary of the cloud service system available to an associated consumer processor device affiliated with the first cloud boundary, the stream of usage data comprising a boundary identification parameter that identifies the first cloud boundary holding the first cloud resource; and
wherein joining the first set of the enrichment metadata with the stream of usage data to generate the first stream of enriched usage data comprises:
generating the first stream of enriched usage data by joining the stream of usage data with a second set of the enrichment metadata selected from the dataset based on the resource identification parameter, the usage time parameter, and the boundary identification parameter.

7. The method of claim 1, further comprising:
refreshing the dataset by:
receiving updated value data representative of an updated value of an item of the enrichment metadata;
associating the updated value of the item of the enrichment metadata with an updated time window defined by updated time window data; and
storing the updated value data in association with the updated time window data in the dataset by adding the updated value data and the updated time window data to the dataset as a new updated time-series data.

8. The method of claim 7, further comprising:
joining stream of usage data with a second set of enrichment metadata at the dataset to generate a second stream of enriched usage data, the second set of enrichment metadata comprising the updated value of an item of the enrichment metadata.

9. The method of claim 1, wherein the dataset comprises an entity map dataset.

10. A system comprising:
a computer comprising a processor device and a non-transitory memory operatively coupled with the processor device, wherein the computer performs a method comprising:
storing in the memory device a dataset comprising time-series data representative of enrichment metadata;
receiving, from an associated source, a stream of usage data representative of use at a reported first time of a first cloud resource of a cloud service system,
the usage data comprising a resource identification parameter that identifies the first cloud resource from among a plurality of cloud resources available in the cloud service system,
the usage data comprising a first usage time parameter that indicates the reported first time; and
joining a first set of the enrichment metadata with the stream of usage data to generate a first stream of enriched usage data, wherein the first set of the enrichment metadata is selected from the dataset based on the resource identification parameter and the first usage time parameter.

11. The system of claim 10, wherein the first set of the enrichment metadata is selected from the dataset based on determining the first usage time parameter to be within a first time window defined by the time-series data of the dataset.

12. The system of claim 11, wherein the method further comprises:
joining a second set of the enrichment metadata with the first stream of enriched usage data to generate a second stream of enriched usage data,
wherein the second set of the enrichment metadata is selected from the dataset based on the resource identification parameter and a second usage time parameter that indicates a reported second time of use of the first cloud resource.

13. The system of claim 12, wherein the selection of the second set of the enrichment metadata is further based on determining the second usage time parameter to be within a second time window defined by the time-series data of the dataset.

14. The system of claim 10, wherein joining the first set of the enrichment metadata with the stream of usage data comprises using a join operation of an associated data processing engine to associate the first set of the enrichment metadata with the stream of usage data.

15. The system of claim 10,
wherein receiving the stream of usage data from the associated source comprises:
receiving a stream of usage data representative of the use at the reported time of the first cloud resource held in a first cloud boundary of the cloud service system available to an associated consumer processor device affiliated with the first cloud boundary, the stream of usage data comprising a boundary identification parameter that identifies the first cloud boundary holding the first cloud resource; and
wherein joining the first set of the enrichment metadata with the stream of usage data to generate the first stream of enriched usage data comprises:
generating the first stream of enriched usage data by joining the stream of usage data with a second set of the enrichment metadata selected from the dataset based on the resource identification parameter, the usage time parameter, and the boundary identification parameter.

16. The system of claim 10, wherein the method further comprises:
refreshing the dataset by:
receiving updated value data representative of an updated value of an item of the enrichment metadata;
associating the updated value of the item of the enrichment metadata with an updated time window defined by updated time window data; and
storing the updated value data in association with the updated time window data in the dataset by adding the updated value data and the updated time window data to the dataset as a new updated time-series data.

17. The system of claim 16, wherein the method further comprises:
joining stream of usage data with a second set of enrichment metadata at the dataset to generate a second stream of enriched usage data, the second set of enrichment metadata comprising the updated value of an item of the enrichment metadata.

18. The system of claim 10, wherein the dataset comprises an entity map dataset.

19. A non-transitory computer readable storage medium having instructions thereon, which when performed in a computer system including a processor device operatively coupled the non-transitory computer readable storage medium cause the computer to perform steps comprising:
storing, in the non-transitory memory, a dataset comprising time-series data representative of enrichment metadata;
receiving, from an associated source, a stream of usage data representative of use at a reported first time of a first cloud resource of a cloud service system,
the usage data comprising a resource identification parameter that identifies the first cloud resource from among a plurality of cloud resources available in the cloud service system,
the usage data comprising a first usage time parameter that indicates the reported first time; and
joining a first set of the enrichment metadata with the stream of usage data to generate a first stream of enriched usage data, wherein the first set of the enrichment metadata is selected from the dataset based on the resource identification parameter and the first usage time parameter.

20. The non-transitory computer readable storage medium of claim 19, wherein the first set of the enrichment metadata is selected from the dataset based on determining the first usage time parameter to be within a first time window defined by the time-series data of the dataset.

21. The non-transitory computer readable storage medium of claim 20, the steps further comprising:
joining a second set of the enrichment metadata with the first stream of enriched usage data to generate a second stream of enriched usage data,
wherein the second set of the enrichment metadata is selected from the dataset based on the resource identification parameter and a second usage time parameter that indicates a reported second time of use of the first cloud resource.

22. The non-transitory computer readable storage medium of claim 21, wherein the selection of the second set of the enrichment metadata is further based on determining the second usage time parameter to be within a second time window defined by the time-series data of the dataset.

23. The non-transitory computer readable storage medium of claim 19, wherein joining the first set of the enrichment metadata with the stream of usage data comprises using a join operation of an associated data processing engine to associate the first set of the enrichment metadata with the stream of usage data.

24. The non-transitory computer readable storage medium of claim 19,
wherein receiving the stream of usage data from the associated source comprises:
receiving a stream of usage data representative of the use at the reported time of the first cloud resource held in a first cloud boundary of the cloud service system available to an associated consumer processor device affiliated with the first cloud boundary, the stream of usage data comprising a boundary identification parameter that identifies the first cloud boundary holding the first cloud resource; and
wherein joining the first set of the enrichment metadata with the stream of usage data to generate the first stream of enriched usage data comprises:
generating the first stream of enriched usage data by joining the stream of usage data with a second set of the enrichment metadata selected from the dataset based on the resource identification parameter, the usage time parameter, and the boundary identification parameter.

25. The non-transitory computer readable storage medium of claim 19, the steps further comprising:
refreshing the dataset by:
receiving updated value data representative of an updated value of an item of the enrichment metadata;
associating the updated value of the item of the enrichment metadata with an updated time window defined by updated time window data; and
storing the updated value data in association with the updated time window data in the dataset by adding the updated value data and the updated time window data to the dataset as a new updated time-series data.

26. The non-transitory computer readable storage medium of claim 25, the steps further comprising:
joining stream of usage data with a second set of enrichment metadata at the dataset to generate a second stream of enriched usage data, the second set of enrichment metadata comprising the updated value of an item of the enrichment metadata.

27. The non-transitory computer readable storage medium of claim 19, wherein the dataset comprises an entity map dataset.
